(19) United States
(12) Patent Application Publication
(10) Pub. No.: US 2014/0330578 A1
(43) Pub. Date: Nov. 6, 2014

(54) ELECTRONIC MEDICAL HISTORY (EMH) DATA MANAGEMENT SYSTEM FOR STANDARD MEDICAL CARE, CLINICAL MEDICAL RESEARCH, AND ANALYSIS OF LONG-TERM OUTCOMES

(71) Applicant: Theodore PINCUS, Chicago, IL (US)

(72) Inventor: Theodore PINCUS, Chicago, IL (US)

(21) Appl. No.: 14/309,847

(22) Filed: Jun. 19, 2014

Related U.S. Application Data
(63) Continuation-in-part of application No. 13/418,504, filed on Mar. 13, 2012, now abandoned.

(51) Int. Cl. G06F 19/00

(52) U.S. Cl. CPC G06F 19/363; G06F 19/322
USPC 705/2

(57) ABSTRACT

An information system and method which corroborates first data provided by data owners and second data provided by data controllers includes a computer and first and second databases. The first database stores the first data and the second database stores the second data. The second data is accessible to the data controllers but not to the data owners. The computer receives from a data owner device first data created using input from one of the data owners, stores the received first data in the first database, transmits the first data retrieved from the first database to an administrator device, receives from the administrator device additional regulated data input by one of the data controllers related to the one data owner, and stores the second data which combines the transmitted first data with additional regulated data in the second database.

### CROSS-REFERENCE TO RELATED APPLICATIONS

This application is a continuation-in-part of U.S. application Ser. No. 13/418,504, filed Mar. 13, 2012 in the U.S. Patent and Trademark Office. All disclosures of the document(s) named above are incorporated herein by reference.

### BACKGROUND OF THE INVENTION

1. Field of the Invention

Aspects of the invention relate to a standardized, semi-quantitative electronic medical history (EMH) data management system and method (FIGS. 1 and 2), based on self-report using a multidimensional health assessment questionnaire (MDHAQ), with several unique features:

According to an aspect of the invention, the MDHAQ (FIG. 3 for new patient and FIG. 8 for return patients) features quantitative patient scores, in contrast to only narrative descriptions, which are integrated into a standard electronic medical history (EMH) (which can be amended by the patient—or the doctor) in an electronic medical record (EMR) (which is a legal document which cannot be changed).

According to an aspect of the invention, quantitative physician scores, in contrast to only narrative descriptions, are collected on a RHEUMDOC form (FIG. 5), and integrated into an electronic medical record.

According to an aspect of the invention, a structured user-friendly format is available for a patient to amend, correct errors, and update information in the EMH (FIG. 4).

According to an aspect of the invention, entry into EMR of most components of medical note,—past history of operations, illnesses, hospitalizations, allergies, medications, family history, social history—into the EMR is possible with no dictation or typing by the doctor (FIG. 6).

According to an aspect of the invention, an electronic version of the structured medical history (EMH) can be made available to the patient to provide to any other health professional, regardless of EMR or other system, which capacity currently is available if other doctor uses same EMR within the same hospital or medical group, but only as non-amendable PDF if not, as is often (usually) the case, so the patient may avoid completing new patient forms over again, with possible errors and inconsistencies (FIGS. 4 and 6).

The invention is available for any clinical medical care, alternative medical care, health maintenance, research or epidemiologic setting.

2. Description of the Related Art

Traditionally and at this time, a patient history is elicited by a physician as the initial component of a patient encounter. In recent years, many physicians have used a self-report questionnaire in order to facilitate acquisition of a medical history. However, the questionnaires used are not in a standard format, although they are roughly 80% identical in all medical settings. Therefore, although the information may be recorded and/or entered electronically, it generally is not transferable from one setting to another, except as copied files which may not be amended or corrected.

A “standard format” refers to all items being in the same order and format, with a computer from to enter the data and transfer to an EMR with no extra burden on a doctor or her/his staff (FIGS. 1 and 2).

Furthermore, quantitative patient self-report scores for physical function, pain, fatigue, exercise status, which often are more prognostic of long-term health than laboratory tests, generally are not included in patient questionnaires collected by most doctors.

A medical record contains a series of notes by a doctor, other health professional, or designated associate to depict each interaction with a patient in an inpatient or outpatient setting, by telephone, Email or other form of encounter. The usual medical record note usually begins with information from a chief complaint, present illness, and other components of a patient history, followed by information from a physical examination of the patient, laboratory tests, ancillary studies and treatment plan. As it is compiled by a health professional in relation to medical treatment, a medical record is a legal document, subject to regulations of the Health Insurance Portability and Accountability Act (HIPAA), as well as other regulations. See 45 C.F.R. 160 and 164, in particular the definitions of “health information” and “protected health information” at 45 C.F.R. 160.103 (as of Jan. 1, 2012). Such information cannot be altered or amended in any way, and disclosure outside certain limited conditions carries penalties.

Information elicited from the patient by the doctor is entered as a patient history into a medical record note, through the physician or an associate writing, dictating, or typing the information. A patient self-report questionnaire provides the information directly from the patient in a standard format (defined above), and with a computer program that can transfer a major portion of the responsibility of providing the initial information from the doctor to the patient. The doctor or associate must still enter the chief complaint and present illness into a record, in a traditional format which is not provided by the questionnaire, and review the information provided by the patient. However, other components of the history (more than 80% in general) including previous illnesses, operations, hospitalizations, family history, allergies, social history, demographic data are provided by the patient and reported in a standard medical record format through the system software.

Furthermore, other than requesting a copy from the doctor, there is no mechanism for the patient to retain the information they enter into a medical questionnaire in one medical setting into another medical setting. This situation allows for errors, inconsistencies and conflicts to exist when patients go between multiple medical offices; such problems could be solved if there existed a single electronic format used in different medical settings, which a patient may amend or correct, saving time and directing effort toward a more accurate medical history rather than entering the information redundantly at many medical settings.

The information can be made available to any other doctor who might not be in the original physician's group or hospital and do not share an EMR with consent of the patient, of course. Most doctors do not have compatible electronic systems and information can be transferred only as a non-electronic file which then requires re-dictation or typing in order to be available in an electronic format.

### SUMMARY OF THE INVENTION

An aspect of the invention includes an information system which corroborates first data provided by data owners (patients) and second data provided by data controllers (doctors), the system including a first database which stores and provides the first data, the first data being accessible to the data owners and the data controllers; a second database which stores and provides the second data, the second data being accessible to the data controllers but not to the data owners; and a computer which controls access of the first data stored in the first database and the second data stored in the second database, receives from a data owner device first data created using input from one of the data owners, stores the received first data in the first database, transmits the first data retrieved from the first database to an administrator device, receives from the administrator device additional regulated data related to the one data owner and which is input by one of the data controllers, and stores the second data which includes the additional regulated data in the second database.

According to an aspect of the invention, the first data includes an electronic medical history (EMH) provided by a patient as the data owner, and the second data includes an electronic medical record (EMR) of the patient controlled by a physician as the data controller.

According to an aspect of the invention, the computer history is reported according to standard format for the medical record from the questionnaire which prompts the one data owner to create the first data according to criterion in the questionnaire, and the received first data includes information prompted by the transmitted questionnaire.

According to an aspect of the invention, the computer further detects the data owner device of the one data owner, retrieves one of the first data stored in the first database corresponding to the one data owner, and constructs the questionnaire relative to the retrieved first data.

According to an aspect of the invention, the computer further retrieves one of the second data stored in the second database corresponding to the one data owner, updates the retrieved second data with the received additional regulated data corresponding to the one data owner, and stores the updated second data in the second database.

According to an aspect of the invention, the computer further detects the administrator device, retrieves one of the second data stored in the second database corresponding to the one data owner, and further transmits the retrieved second data to the administrator device.

According to an aspect of the invention, the computer receives from the administrator device updated second data including the additional regulated data input by one of the data controllers related to the one data owner, and stores the updated second data in the second database.

According to an aspect of the invention, the computer further detects the administrator device, receives a query from the administrator device to search for specified information in the first database for a plurality of the data owners, retrieves a search result for the specified information, and transmits the retrieved search result to the administrator device.

According to an aspect of the invention, the computer receives a request for research data from an external device, retrieves first data from the first database responsive to the request, removes from the retrieved first data personal information of the corresponding data owners to create the de-identified research data, and transmits the created research data to the external device. While not required in all aspects, this information is given only if consent by the patient data owner is given (which most patients willingly offer to gain better long-term knowledge of their disease and results of treatment).

According to an aspect of the invention, the received request for research data is limited to specific categories of information, the computer searches the first data from the first database responsive to the specific categories in the request to obtain a search response, and removes from the retrieved search response the personal information of the corresponding data owners to create the research data.

According to an aspect of the invention, the computer further sends a reminder message to the one data owner which prompts the one data owner to update the first data according to the criterion in the reminder message, and the received first data includes information prompted by the transmitted reminder message. While not required in all aspects, this reminder message is sent only if consent is given (which most patients willingly offer to gain better long-term knowledge of their disease and results of treatment).

According to an aspect of the invention, the system further includes the administrator device which receives the additional regulated data input by the one of the data controllers and which is related to the one data owner, receives the first data for the one data owner, and transmits the additional regulated data to be stored with the second data in the second database.

According to an aspect of the invention, the system further includes the data owner device which receives the input from the one of the data owners to create the first data, and transmits the created first data.

According to an aspect of the invention, the system further includes a data storage device accessible to the data owner device, where the transmitted first data is further stored in the data storage device and is retrieved according to a request received from the computer for an update to the first data.

According to an aspect of the invention, the first data comprises information from a completed multidimensional health assessment questionnaire (MDHAQ) (FIG. 3 for first visits and FIG. 8 for subsequent visits), and the second data comprises a medical record including regulated data regulated under the Health Insurance Portability and Accountability Act (HIPAA), as well as other regulations.

An aspect of the invention includes a method of corroborating first data provided by data owners and second data provided by data controllers, the method including: sending a questionnaire with quantitative scores from a computer to a data owner device of one of the data owners to provide information used to create the first data for the one data owner; receiving the created first data at the computer from the data owner device; storing the received first data in a first database which stores and provides the first scores, the first scores being accessible to the data owners and the data controllers; retrieving second data related to the one data owner from a second database which stores and provides the second data, the second data being accessible to the data controllers but not to the data owners; transmitting the retrieved second data from the computer to an administrator device of one of the data controllers; receiving regulated data from the administrator device, the regulated data corresponding to the received first data and the transmitted second data of the one data owner; and storing the received regulated data as updated second data in the second database.

According to an aspect of the invention, the method further includes transmitting from the computer to the data owner device questionnaire scores which prompt the one data owner to create the first data according to the criterion in the questionnaire, and the received first data includes information prompted by the transmitted questionnaire.

According to an aspect of the invention, the method further includes the computer detecting the data owner device of the one data owner, retrieving one of the first data stored in the first database corresponding to the one data owner, and constructing the questionnaire relative to the retrieved first data.

According to an aspect of the invention, the method further includes the computer combining the retrieved second data with the received regulated data corresponding to the one data owner to create the updated second data.

According to an aspect of the invention, the method further includes the computer receiving from the administrator device the updated second data including the regulated data input by one of the data controllers related to the one data owner.

According to an aspect of the invention, the method further includes the computer receiving a query from the administrator device to search for specified information in the first database for a plurality of the data owners, retrieving a search result for the specified information, and transmitting the retrieved search result to the administrator device.

According to an aspect of the invention, the method further includes the computer receiving a request for research data from an external device, retrieving first data from the first database responsive to the request, removing from the retrieved first data personal information of the corresponding data owners to create the research data, and transmitting the created research data to the external device.

According to an aspect of the invention, the received request for research data is limited to specific categories of information, and the method further comprises the computer searching the first data from the first database responsive to the specific categories in the request to obtain a search response, and removing from the retrieved search response the personal information of the corresponding data owners to create the research data.

According to an aspect of the invention, the method further includes the computer sending a reminder message to the one data owner which prompts the one data owner to update the first data according to the criterion in the reminder message, wherein the received first data includes information prompted by the transmitted reminder message. While not required in all aspects, this reminder message is sent only if consent is given (which most patients willingly offer to gain better long-term knowledge of their disease and results of treatment).

According to an aspect of the invention, a non-transitory computer readable medium encoded with processing instructions readable by the computer to implement the method.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a chart showing the various components of the system, including optional components, and the interactions between them, according to aspects of the invention;

FIG. 2 is a chart showing the various components of the system, including a first and second patient visit components, and the interactions between them, according to aspects of the invention;

FIGS. 3A-3D is an example of a MDHAQ patient questionnaire for new patients which includes patient information and quantitative scores of a patient's condition;

FIGS. 4A-4C is an example of a patent review form which enables patients to review their medical records and amend, make corrections or add information of their medical histories;

FIGS. 5A-5B is an example of a specific doctor form, the purpose of which is to transform narrative information into quantitative scores from the doctor's perspective

FIG. 6 is an example of a standard doctor's note made in accordance with the systems shown in FIGS. 1-2;

FIG. 7 is a flowchart describing the creation process of an EMH, according to aspects of the invention;

FIGS. 8A-8B is an example of a MDHAQ patient questionnaire for return patients which is integrated with data in the EMH which a patient may amend, correct, and update.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

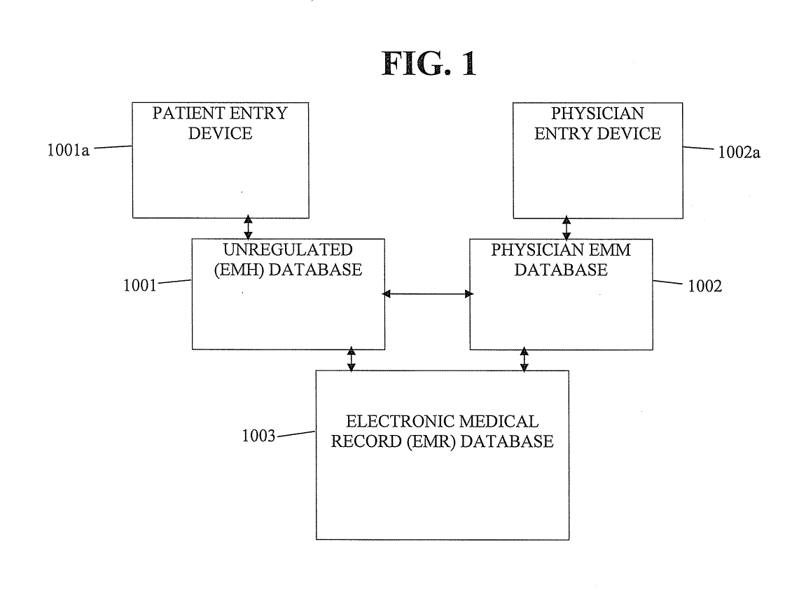

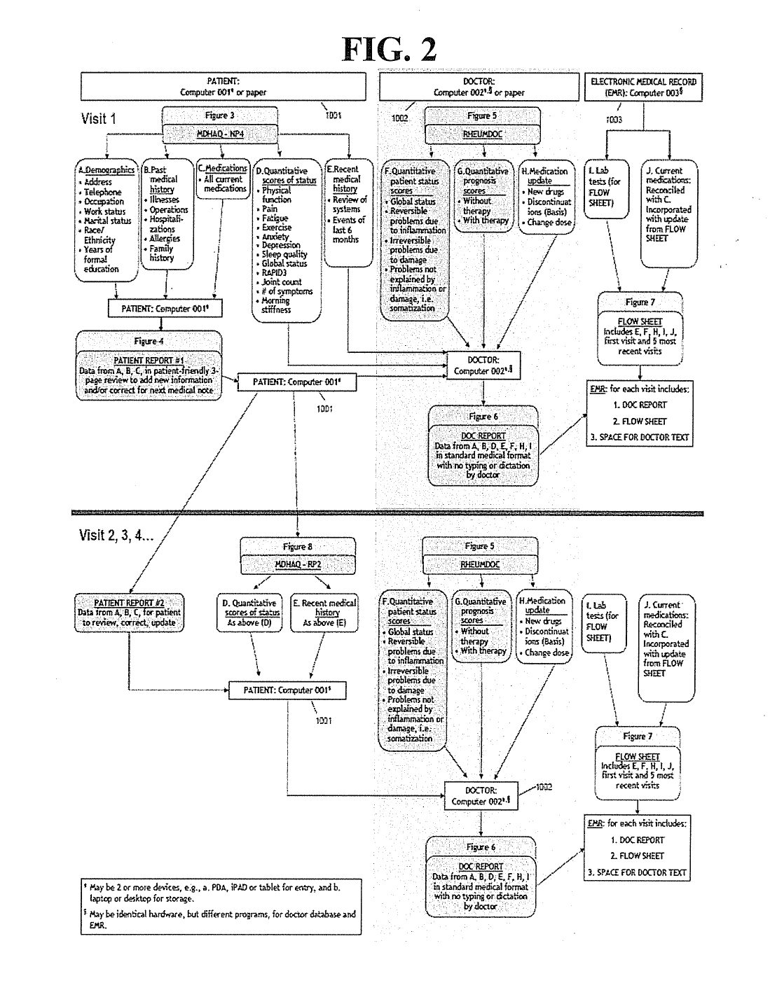

Although the exemplary embodiments in FIGS. 1 and 2 describe the invention in terms of physicians, patients, and medical data, such description is only for convenience. The invention is not restricted to clinical encounters or the medical field, and can be used for any system where a piece of information is ideally shared among multiple parties in a standardized format, yet is frequently associated with other information that cannot be so shared due to confidentiality or regulation or cannot be stored in a standardized format. In this manner, there are data owned by and updatable by a private party in one database, and related data which are not updatable by the private party in another database.

By way of example, one option might be to include a personal data file, so that an individual could include a listing of bank accounts, brokerage statements, tax returns, will, insurance policies, which could interact with this system so as to allow third parties to accurately record personal information in internal databases which are not accessible to the person and allow the third party to more accurately advise the individual. Examples where this system would be useful would be in financial systems, such as for loan applications, or where the individual needs to ensure their credit record is accurate.

Another example would be to have the system allow a personal data file to interact with records of Government agencies, thereby facilitating the obtaining of Government documents (such as drivers licenses, passports) or security clearances. A further example would be implementation of the system in a school, thereby allowing students or guardians to control information on a student's academic, personal and/or health records, which could then be used by school officials at a new (or existing) school to create or update official records (possibly limited by consent requirements). As such, the system is usable in a number of situations where one party requires accurate records of another party but cannot allow that other party to directly access or change these records.

However, for purposes of explanation, an implementation relative to a medical system will be described. As background, an electronic medical history (EMH) provides one component of an electronic medical record (EMR), in which all information is completed by the patient, prior to availability, review, and synthesis by a health professional. The medical history usually comprises 50-75% of the medical record note. The proposed EMH system allows the patient to be in control of her/his medical history information prior to any encounter, which can be modified by a physician, although once entered by a physician into an EMR, the EMR remains in the control of the physician, and is a legal document which cannot be edited or altered.

Many if not most medical records contain several errors, most of which are innocuous, but some are serious. An example of such an error could include an incorrect date of surgery. These errors are often propagated in an EMR through “cut and paste” of information within a given clinical setting, without further review by a patient. The EMH cannot correct errors which are already entered into a medical record, whether electronic or paper, as this information remains legally outside of change. However, the EMH provides a patient with an opportunity to update, amend, correct, and enter missing data into his/her medical history before or at future encounters. A revised EMH would then be available to any physician or health facility designated by the patient to be available for review and possible entry into a future medical note in an EMR at any time.

According to an aspect of the invention, the standard, quantitative information collected in usual medical care is organized into an electronic format. This electronic format can then serve a number of purposes, including:

a. An EMH that can be entered into a standard medical note in a standard “medical” format, saving the doctor 5-20 minutes for a new patient and 3-10 minutes for a return patient.

a. Includes MDHAQ quantitative scores for physical function and exercise, as well as for pain, fatigue and global status, to document improvement, worsening, or stability of these common medical symptoms. Poor scores of which have been shown to predict reduced survival in the range of smoking.

b. If the patient consents, the EMH can be made available to the patient in electronic media to be updated, amended, or corrected by the patient over a lifetime. Examples of electronic media include a memory stick, disc, internet password-protected website or shared storage, or like media.

c. If the patient consents, the EMH can be made available for all future encounters with any health professional, to save time for the patient and doctor and improve accuracy of the medical history.

d. If the patient consents, the EMH can be made available in a standard format for research studies, with the patient's consent of de-identified data analyzed only in groups for prognosis, predictors of poor and good outcomes, and responses to various therapies, with minimal costs incidental to standard care for collection of the data (although costs of analyzing the data will remain).

e. If the patient consents, the system will send periodic notices to provide the patient an opportunity to update, amend, and correct her/his medical history, so that any current medical history is always available. This is far preferable to updating only in medical settings or, worse, emergency circumstances.

However, the electronic format need not serve all of these purposes and can serve other purposes. Moreover, it is understood that in a non-medical or non-clinical implementation, the electronic format can serve other purposes which may or may not be consistent with the above-noted purposes.

According to an embodiment of the invention shown in FIGS. 1 and 2, the system includes a computer 1001 for the owner (patient), 1002 for the provider (doctor) and 1003 (an EMR). Computer 1001 for the patient may include 2 or more devices, a personal data assistant (PDA), I pad, or tablet to enter data, and a laptop or desktop computer to score the data. Similarly, Computer 1002 for the doctor may include 2 or more devices, a personal data assistant (PDA), I pad, or tablet to enter data, and a laptop or desktop computer to score the data. Computer 1002 for the doctor database and 1003 for the EMR may be the same device with clearly different programs. The computers 1001 and 1002 can be a general or special purpose computer, a server, or any collection of processors capable of implementing programming instructions in relation to the databases 1002, 1003. By way of example, the system can be implemented using a personal computer using a standard commercial database program, such as ACCESS from Microsoft, but the invention also allows for use of custom databases depending on the needs and scale of the practice in question. Lastly, it is understood that additional databases can be used by the computer 1001, such as those related to accounting, communications, or other organized information.

Database 1001 contains non-regulated information. In the context of a medical system, the database 1001 would contain electronic medical histories (EMHs) for patients which are not regulated by privacy laws such as HIPAA. In this sense, the database 1001 stores user data which is owned or controlled by the user (i.e., a data owner).

The other database 1002 contains confidential information scored by the doctor, and Computer 1003 contains regulated electronic medical records (EMRs) for the patients which are regulated by privacy laws such as HIPAA. These are legal documents. In this sense, the database 1003 contains stored information about the user which is neither owned nor controlled by the user, although the user can request the data controller update its records. In the present example, the data controller can be a physician, a health professional, hospital, or other medical facility. In another example, the data controller can be an insurance carrier. However, it is understood that the data controller is not restricted to such examples, and especially in non-medical implementations not restricted by HIPAA.

A patient may use an entry device to interact with the computer 1001. While not limited thereto, the patent's device can be a smart phone, tablet, a personal computer, or similar electronic device which interacts with the computer 1001 across a wired and/or wireless network. Specifically, the device and computer 1001 are used by the patient to create and/or update the EMH.

By way of example, the computer 1001 obtains or creates an EMH associated with the patient. In the shown embodiment, the patient device creates this EMH in response to a series of questions sent electronically to the computer 1001. While described in terms of the patient directly entering the information with the patient device, it is understood that in aspects of the invention, the patient completes the series of question on paper, and another person enters this data into the device 1001. In another aspect, the questions could be completed by a surrogate electronically (examples of the surrogate can be a spouse or other relative, nurse or other health professional), and the surrogate would enter the answers into the patient device 1001. In this way, the patient device 1001 can be a device used and owned by the patient, or simply any device through which the patient's answers are entered.

In a further embodiment of the invention, this series of questions is the series listed in an electronic multidimensional health assessment questionnaire (MDHAQ) provided by the computer 1001. Examples of such questions include traditional medical history queries and quantitative scores for physician function, pain, global status, fatigue, and exercise frequency. Using an MDHAQ or similar questionnaire in a standardized format for use in multiple office systems, which allows the information to be stored locally in the device and reused in multiple different medical office settings.

When the questions are completed, the device creates and stores an EMH in computer 1001. By way of example, the data in computer 1001 with the EMH retrieved is sent to computer 1002, the doctor's database, and Computer 1003, the EMR.

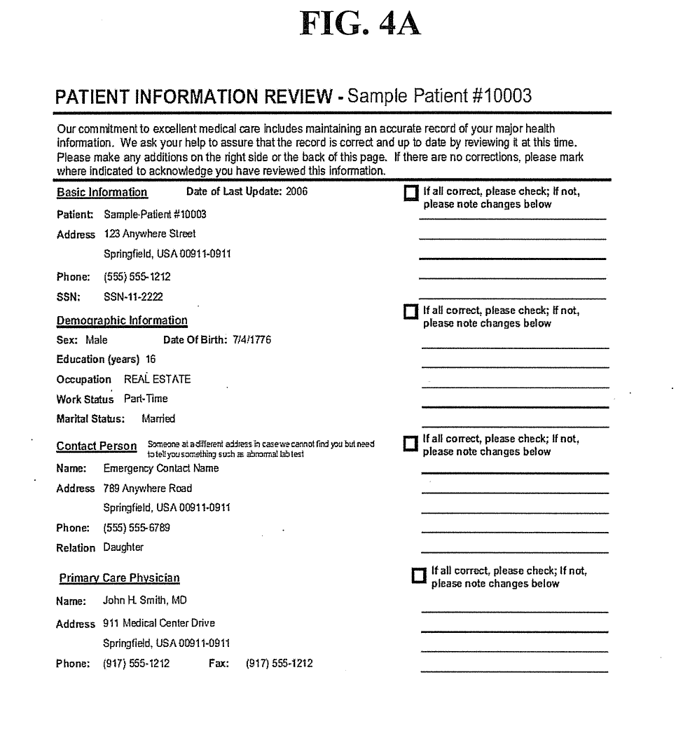

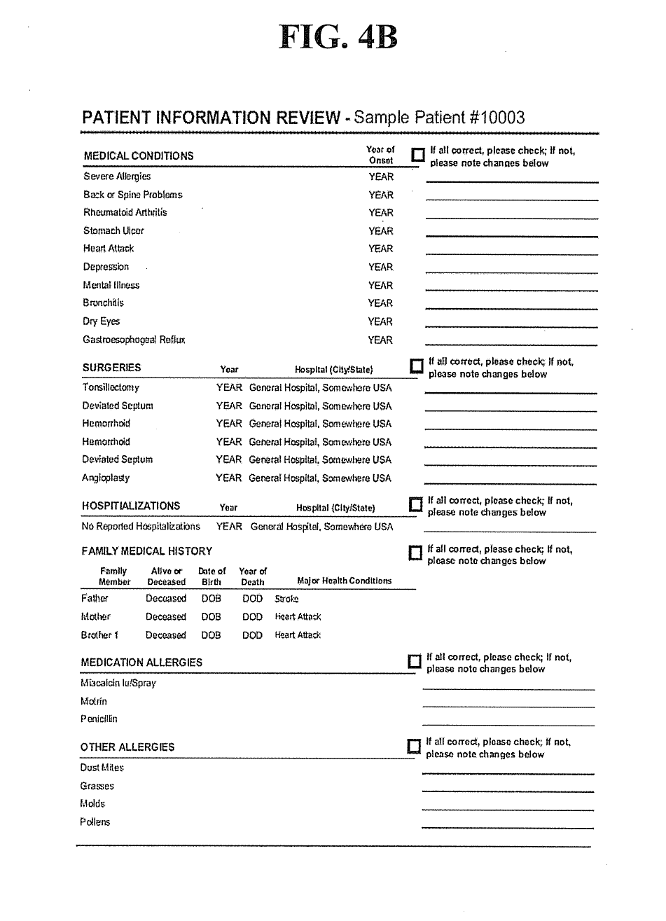

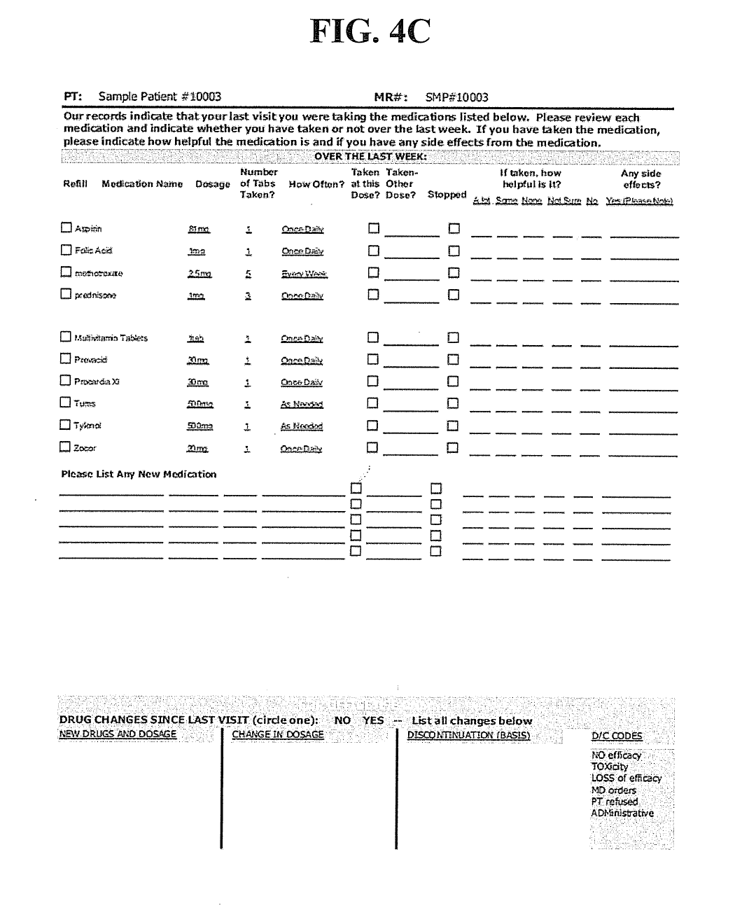

By allowing updates to the EMH on computer 1001 (FIG. 4) and continued use of previously-entered data, the patient, who may not otherwise remember information such as the year of an operation or a major medication taken at an encounter, would be able to provide this information to the physician and provides an opportunity to gather this information at a later time, and then have it entered into the “memory” of the computer 1001 indefinitely.

In some embodiments of the invention, the computer 1001 serves as an email server and the EMH database and sends the data to computer 1002.

Once the EMH is created, the EMH database is stored in computer 1001. Where the storage 1001 is detachable or a cloud drive, aspects of the invention allow the computer 1001 or the physician's device 1002 to access the stored EMH. While not required in all aspects, the computer 1001 may provide the EMH for viewing on the patient's device to retrieve the EMH from the storage,

In an embodiment of this invention, upon creation of the EMH, the computer 1001 automatically provides the EMH to the doctor's device 1002 immediately and without prompting. In this way, the EMH can be synchronized between devices 1001 and 1002. Moreover, where both the database 1001 and 1002 have different copies of the EMH, the most recent version can be adopted by the computer 1001 to ensure that the database 1002 always includes the most current patient EMH information.

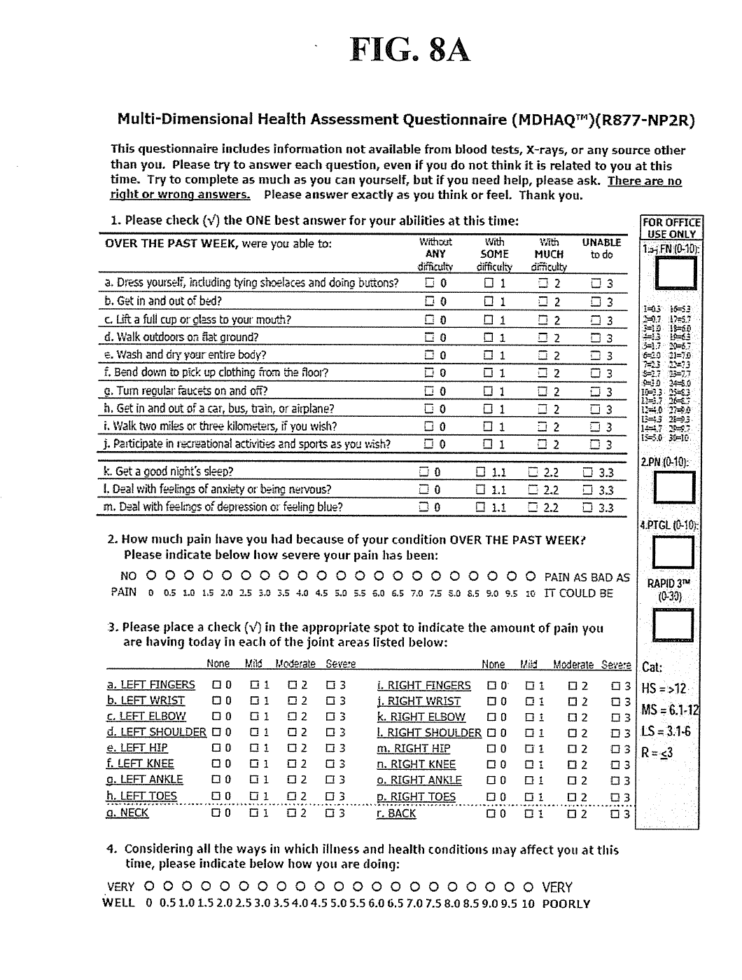

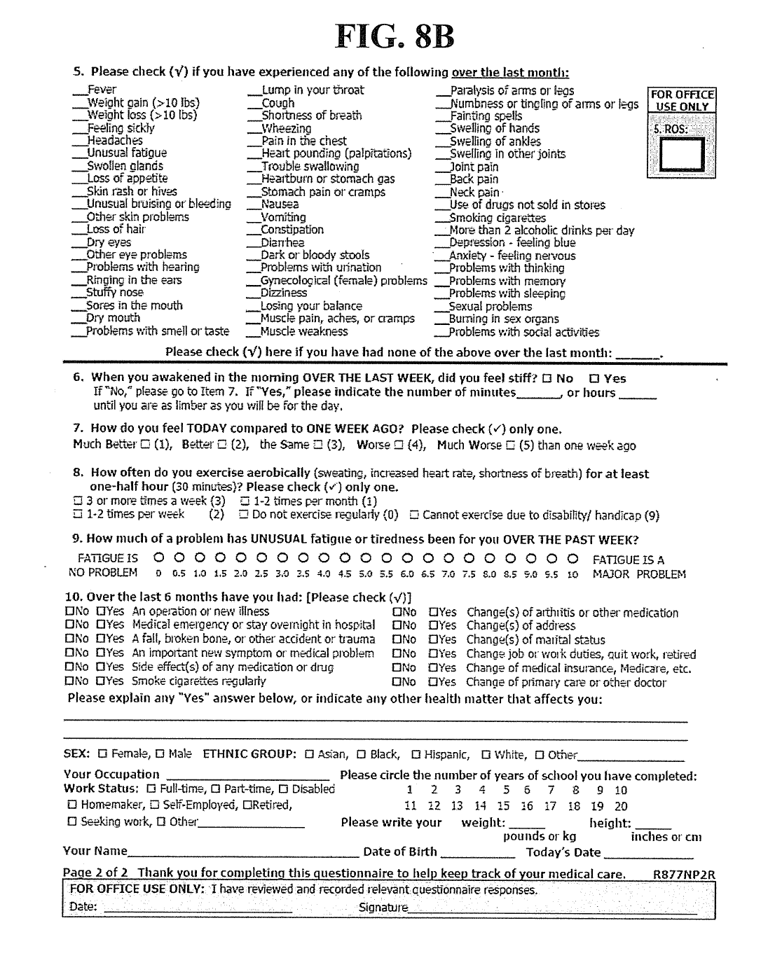

In an embodiment of this invention, a given patient may substitute one device for another with each interaction with computer 1001. For example, the computer 1001 might provide an MDHA (FIG. 8) and Patient Information Report (FIG. 4) to a home computer one day, a tablet another day, and a mobile device another day. In another embodiment, a given patient must always use the same device to interact with computer 1001. In another example, the patient might purchase or upgrade a new device, whereby the EMH is transferred to the upgraded device. In this manner, the EMH is controlled by the patient and is available using any device which the patient may choose independent of the main computer 1001.

Once it creates the EMH, the computer 1001 may also provide the EMH to the device 1002 of an administrator party (in this embodiment, a physician). The computer 1001 may later update the EMH stored in the database 1002, through further information received from either the physician's or the patient's device.

In some embodiments of the invention, the computer 1001 may also create in the database a copy of a previously-created EMH. This copy may, in various embodiments, be received from the physician's or patient's device, directly connected to the computer 1001, or combinations thereof.

Additionally, the computer 1001 may attach confidential information if requested specifically by the patient of a physician, hospital, or other medical facility, received from the physician's device, to an EMH on computer 1001 to create an EMR or a future note in the EMR. Such a record is not controlled by the patient in the sense that the patient lacks authority to update the EMR, and therefore requires that the physician or a member of the practice create or update the EMR in each instance of such transfer. Such a creation or update is generally based on a face-to-face encounter, but possibly can be accomplished based on telephone, email, or other interaction without direct dialog or a physical examination.

However created, the computer 1001 stores this EMR note from the EMR database 1003. The computer 1001 may later provide this EMR note to the physician's device 1002, and the computer 1001 can add to the EMR new information transmitted from physician's device 1002. By way of example, the physician could review the EMH provided by the computer 1001, select information in the EMH to be included in the EMR as the new information, and transmit the new information to be included in the EMR by the computer 1001. In another example, the physician's device 1002 could have authority to directly update the EMR, in which case the physician could review the EMH provided by the computer 1001, copy information from the EMH into the EMR, and transmit the updated EMR back to be stored in the database 1001. In this way, the patient's EMH is kept current by the patient, and this format can be copied into/synchronized with an EMR under the direction of the physician to also keep the EMR current.

In an embodiment of the invention, assuming the patient has been given access by the physician under appropriate HIPAA laws, the computer 1001 may provide the EMR of a given patient to the doctor's device 1002. This may include important information to be available to other health professionals, such as a lab test report, electrocardiogram, X-ray, MRI, etc. Such an EMR would be created as an EMH by the other health professionals until adopted formally as an EMR under the direction of another physician. Also in an embodiment of the invention, the computer 1001 may add EMR data to a patient's EMH (an action depicted in FIG. 2) only when interacting with that patient's device 1001. However, it is understood that in other aspects, copies of data included in the database 1003 cannot be provided to the computer 1001.

While not required in all aspects, the computer 1001 can also provide to the physician's device 1002 one or more standard computations of information about one or more EMHs stored in the database 1001. Such computations can be in response to a specific search query from the physician, but can also be pre-determined reports established in the computer 1001 relating to standard information requested by physicians in general. These computations may include but are not limited to: how many patients with each diagnosis are seen in the practice, how many patients with each diagnosis take specific medications, and what is the change in patient scores for physical function, pain, and global status associated with treatment with specific medication in specific individual patients over time.

In this manner, the physician can use the EMH data to review and analyze a practice as a whole to recognize proportions of patients with a given diagnosis, treatment, response of scores for pain, fatigue, etc., and detect trends in care as well as search the database 1002 to find how specific ailments have been treated in the past and at what success rate. The result of these computations could be displayed as standard reports, the results of search queries, graphs etc. By way of example, the physician could use a search engine installed in the computer 1001 to conduct searches of EMH data in the database 1002 based upon specific keywords. However, it is understood that such computations need not be performed in any or all aspects, and aspects can be limited to simply providing the EMH for clinical care.

In an embodiment of this invention, the computer 1001 associates databases 1002 and 1003 such that if the computer updates an EMH in database 1002, it will automatically update the corresponding EMR in database 1003 with the same new information or automatically prompt the physician to approve of such changes depending on the requirements for compliance with HIPAA.

While not required in all aspects, the patient or physician may substitute one device for another with each interaction with computer 1001 and/or 1002; for example, the computer 1001 might receive an EMR update from a laptop one day, and from an office computer another day, or a hospital computer. In another embodiment, the physician must always use the same device 1002 to interact with the computer 1001.

While not required in all aspects, the computer 1001 may also provide the EMH to a device of an outside party, such as another physician, with consent of the patient. The other physician could access the computer 1001 using a password provided to that physician. The other physician could be in the same practice, or could be in another practice but needs the EMH of the patient for clinical care decisions. In another embodiment, the patient could give advance consent to allow the EMH to be accessed by a third party physician in the event of an emergency or where the patient is incapacitated as in the case of a coma. In this way, the EMH can be kept updated between different offices, thereby minimizing the potential for errors in medications, missing data concerning severe side effects, and comorbidities. However, it is understood that such sharing need not apply in all aspects and may be restricted by patient preference and/or laws and regulations governing privacy, and that all entries by the patient must be reviewed and approved by a physician or other health professional before incorporation into a medical record, whether paper or electronic.

If an EMH is saved either to detachable data storage or to an internal memory of a device, either may directly provide the 1003 EMH file to one or more of devices 1001 or 1002. In this manner, the patient can share the EMH with the physician without accessing the computer 1001, which could occur in emergency situations or when or where the computer 1001 is otherwise not available.

In at least some embodiments, the computer 1001 may provide an EMH to another party's device 1002 only if the content of the EMH allows it. The key content for allowance may, depending on the preferences of the owner of the computer 1001, be a simple can/cannot share binary value, selected by the patient's device. It may alternatively, or in combination with the binary value, be related to other contents such as a specific diagnosis (which would make the EMH accessible to specialists in that field), place of residence (which would make it accessible to other physicians in the area), or list of other physicians treating the patient (which would make it accessible to those specific physicians). Such methods of filtering access are by no means limited to the above options.

In an embodiment of the invention shown in FIG. 2, the computer 1001 provides 1102 a single or multiple EMHs to a device of an outside party that seeks patient information but does not need the associated identifiers. Examples of such an outside party include a research group, educational institutions, or groups or organizations of physicians looking for rates of successes of potential treatments. In aspects of the invention, such providing has the EMHs stripped of information that could identify the associated patient at a public computer, but encrypted for identification in longitudinal studies within the database.

While not required in all aspects, the computer 1001 could provide 1002 computations from the EMHs stored in the database 1001, in addition to or instead of the EMHs themselves. Examples of such computations include but are not limited to: how many patients with each diagnosis are seen in the practice, how many patients with each diagnosis take specific medications, and what is the change in patient scores for physical function, pain, and global status over time. In this manner, outside groups, such as research institutions, can also benefit from the improved EMH collection system without having to rely on handwritten questionnaire responses from physicians, which also increases the likelihood that such information will be shared due to the ease of doing so.

In a similar manner and using similar filtering methods, in at least some embodiments, the computer 1001 may only provide an EMH stripped of identifying information by encryption or entirely de-identified for a “locked” database for analysis to specific researcher devices, or none at all.

The possible methods of connecting the various devices are not limited and may be appreciated by those skilled in the art, but can include wired and wireless networks, mobile phone networks, the Internet, or a USB connector, to name but some options. Likewise, the methods used to create an interface between the devices may include but are not limited to firmware, installed software, or web applications.

Also, in at least some embodiments, one, some, or all other devices may exist only as interfaces of computer 1001, such as where a Citrix server relays an interface to a remote device whereby the interface is under the control of the computer 1001 and the receiving device acts merely as a display for the computer 1001. In another embodiment, multiple devices may be the same device with separate interfaces for each purpose.

In an embodiment of the invention shown in FIG. 2, the computer 1001 will send reminder messages to a patient to prompt the patient to update their EMH. These reminder messages can be optional, although the invention is not restricted thereto. These reminders may be periodic, may come after specific events (such as a major treatment), or both. These reminders will suggest that the patient provide 1001 with any new information so that the computer 1001 may update the EMH. The form of these reminders is not limited and may, to name but a few examples, take the form of emails, text messages, or automated phone calls. Also in an embodiment, the EMH's content includes a can/cannot remind value, selected by the patient's device or the physician's device during creation or updating of the EMH, which will determine whether, and in what form, reminders will be sent; a “can remind” value will add the patient's name to the optional EMH registry/outcomes database. In this manner, the patient can easily apprize the physician as to the progress they are making in a treatment, the extent to which they are complying with the physician's instructions, and any side effects they are feeling without relying on later reconstructions when the patient next visits the physician.

In an embodiment, multiple physicians all use the same computer 1002, for example, through a shared cloud computing system. In such cases, the computer 1001 provides 1102 any EMH to any physician using the system, under the limits of the EMH's contents, with each physician using a personal device 1002 for access.

In another embodiment, each physician possesses her own computer 1002, and EMHs can be transferred as each physician requires it. Methods of transferring EMHs between such databases are numerous and quickly apparent to those of ordinary skill in the art. One such method might be that a computer 1001 may provide an EMH to another indirectly, by saving 1101 first to data storage, while the second computer 1002 then creates a copy of the EMH by retrieving the information from the data storage. Another such method might be that one computer 1001 directly to the EMH.

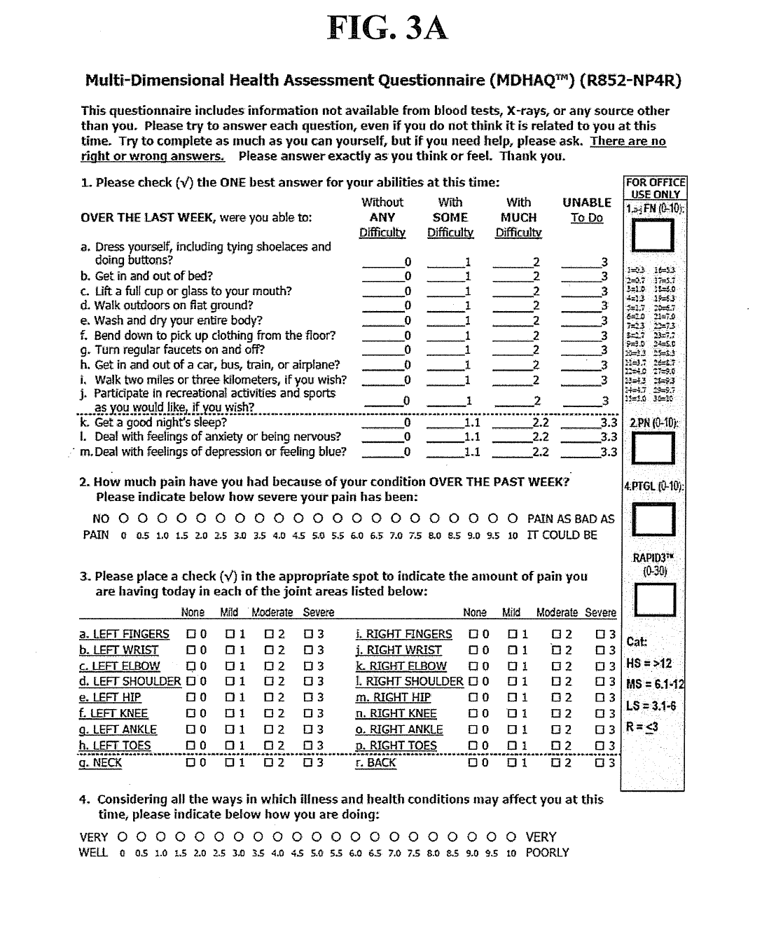

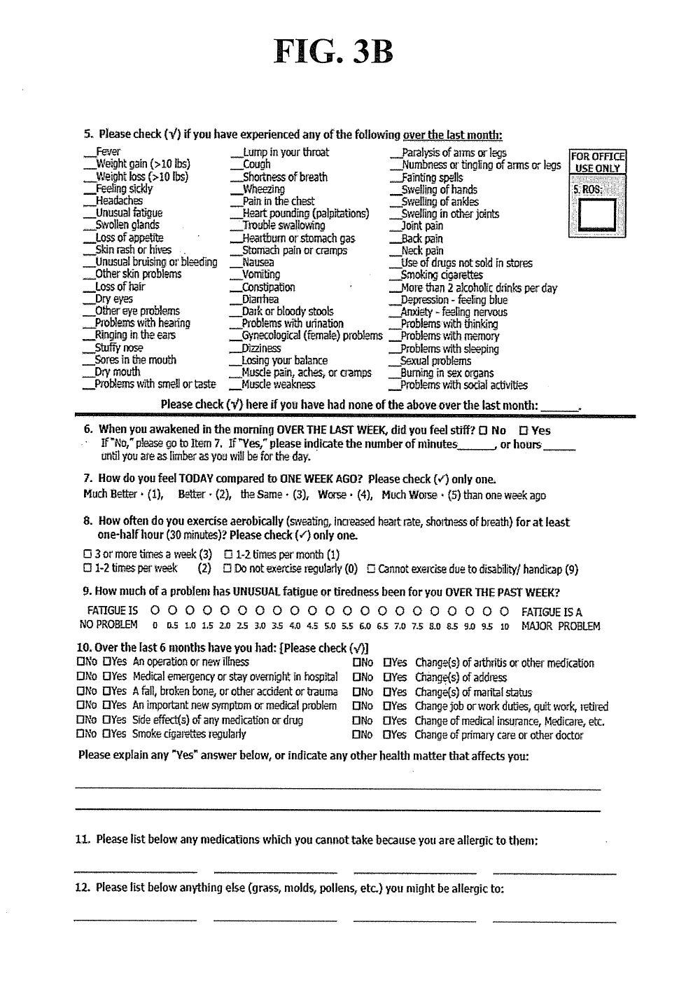

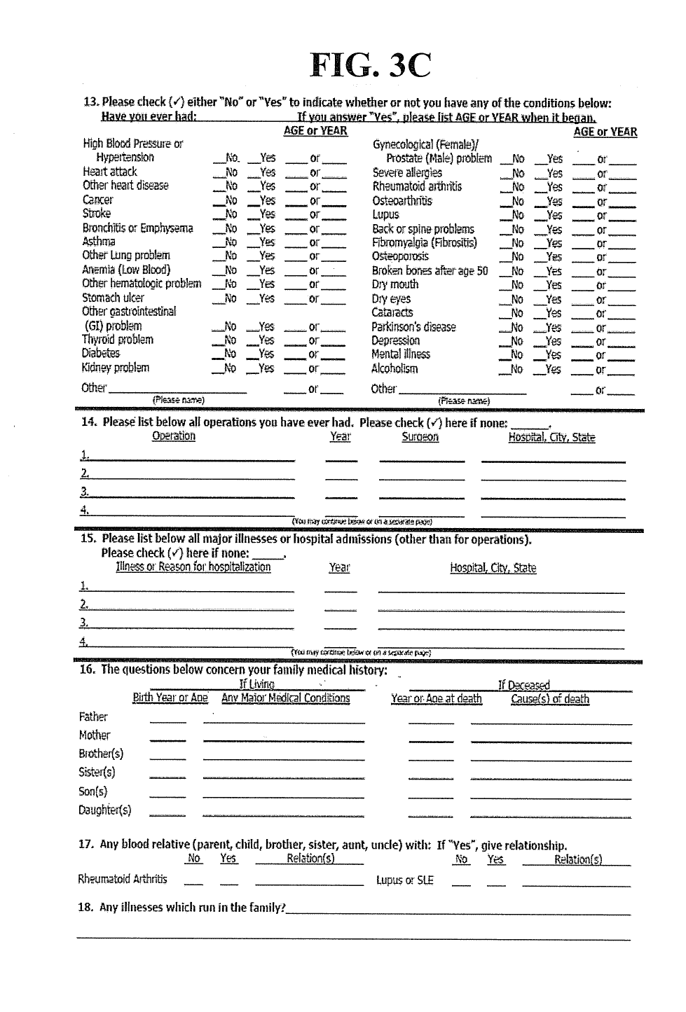

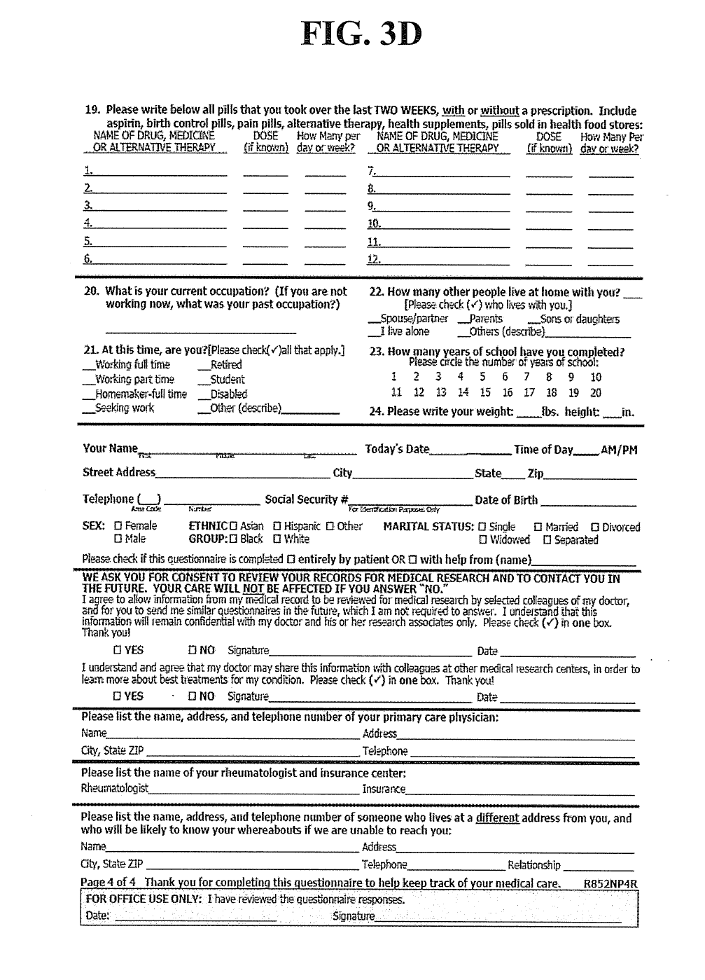

FIG. 2 examines one process of creating the EMH in depth. The patient first completes the multidimensional health assessment questionnaire (MDHAQ) (FIG. 3). As can be seen, this questionnaire covers the traditional medical history, the patient's self-reported status, and demographics of the patient. The MDHAQ is derived from the health assessment questionnaire (HAQ) to include physical function in 10 activities, pain, global status, fatigue, self-report joint count, review of systems, recent medical events, morning stiffness, change in status, and demographic data on two sides of one page. MDHAQ includes scoring templates for physical function, pain, global status, fatigue, and self-report joint count, all scored 0-10, as well as templates for composite routine assessment of patient index data3 (RAPID3), which can be scored in 10-20 seconds in a busy clinical setting.

For instance, in the shown MDHAQ, there are three types of information. First, there is the traditional medical history in a standard format e.g., medications, Surgeries, Illnesses, Family History, Hospitalizations, Allergies. Next, there is Patient self-reported status using quantitative scores using a scale such as 0 to 10 with each status having a different weight (e.g., Physical function, Fatigue, Pain, Sleep, Global status, Anxiety, Exercise status, Depression). Lastly, there is Demographic data (e.g., Date of birth, Education level, Race, Occupation, Marital status, Work status). A more detailed description of MDHAQ questionnaires can be found at Pincus T, Swearingen C J., The HAQ compared with the MDHAQ: “keep it simple, stupid” (KISS), with feasibility and clinical value as primary criteria for patient questionnaires in usual clinical care. Rheum Dis Clin North Am 2009; 35(4):787-98, and Pincus T, Sokka T. Quantitative Clinical Rheumatology: “Keep It Simple, Stupid” (KISS): MDHAQ Function, Pain, Global, and RAPID3 quantitative scores to improve and document the quality of rheumatologic care. J Rheumatol. 2009; 36(6):1099-100, the disclosures of which are incorporated by reference.

There are currently different types of MDHAQs, such as FIG. 3 for new patients and FIG. 8 for return patients. All offer a mechanism for standardization of information taken in which is independent of the specific office. The use of the system reduces the burden on the office and the patient, thereby improving the quality of information received and hence the quality of care received. While described in terms of a MDHAQ, it is understood that other questionnaires can be used or developed to elicit information usable to construct or update an EMH in other aspects of the invention.

When the questionnaire is completed, the resulting data is reported both to the patient, at 1001, and to the physician, at 1002. The patient may use the opportunity to review the data and revise it; if he does, the revised data is again sent to the physician at 1002. The physician, having also reviewed the data, passes it to the EMH database 1002; this also creates a “flowsheet” tracking all changes expressed in the EMH. The physician also adds regulated data to create an EMR at 1003. While not required in all aspect, the data is examined by both the patient and the physician before it is added to a database. It is understood that the database can be updated prior to review of the physician in other aspects.

In one embodiment, when the EMR is created, the patient may request a revised EMH from its data in FIG. 4. While not required in all aspects, the patient may create the revised EMH with appropriate consent. These data are then reviewed by the physician at 1002 and added to the EMH database at 1003. In this manner, there is a uniform mechanism by which a patient can request an update in the EMR and record their request in an EMH.

While reviewing the data, the patient may also volunteer for reminders, which will remind the patient to review the data again at various intervals. The patient may also set options for how to store and update the data at 1001.

Thus, one aspect that is significant with respect to the systems shown in FIGS. 1-2 is what type of information that might be communicated the capacity to communicate information that is not available in other systems that have been used in the industry.

In the medical industry, for example, structured patient questionnaires have not been used. Of course, patient questionnaires and patient history is often taken on a questionnaire when one visits a doctor's office, hospital or other health care facility. However, the traditional approach is to have narrative information for the patient history without quantitative data.

As described below, there is a vast difference between narrative information and quantitative data in trying to make an assessment if the patient is better or worse over time, particularly in chronic diseases where the memory of both the patient and the doctor may be faulty over periods of months to years, not to mention that there may be different healthcare providers involved over longer periods.

Furthermore, using the systems previously described according to aspects of the present invention, capability is provided for patients to amend, correct, and otherwise change the medical history information for future recording. Further details of such aspects are provided as follows. Self-report questionnaires, questionnaire scores, doctor scores, quantitative patient information, quantitative patient data, and quantitative patient scores as set forth herein have not been used by service providers, particularly in the health care industry.

Some of the novel aspects of the present invention include:

patient scores (in contrast to only narrative descriptions) for medical history; physician scores (in contrast to only narrative descriptions) for impressions of physical examination; structured physician estimates of prognosis, without and with therapy; structured format for a patient to amend, correct errors, and update medical history information; and control of data by the patient, who will be able to give a structured medical history to any other health professional, thereby avoiding the need to complete new patient forms over again, with possible errors and inconsistencies.

The guiding principles include less work for doctor, helping a patient prepare for a visit and improve doctor-patient communication, and provide for better documentation, and minimal interruption of patient flow.

The unique feature of CLINDAT is not a patient questionnaire, which are widely used, nor extensive interactive hardware between patient and doctor as a patient portal, doctor computer and EMR, but a unique patient questionnaire and follow-up management system that has the following features that differ from the standard or even highly patented systems:

The patient questionnaire, the MDHAQ, of which only one example is provided in FIGS. 3A-3D, includes quantitative scores rather than simple narrative descriptions of some of the most prominent reasons for visits to a doctor, including: (a) physical function; (b) pain; (c) fatigue; (d) global status; (e) number of symptoms in review of systems; (f) global estimate of status; (g) exercise status; and (h) change in status.

Entry of medical history information by the patient on such a standardized form enables the patient to prepare for a doctor's visit and for the doctor to improve accuracy and save time. In this example, the MDHAQ includes recent medical history over the previous 6 months, including hospitalizations, operations, illnesses, trauma, change in medications, side effects of medications, smoking, change of address, work responsibilities, marital status, insurance, and primary care doctor.

This information will help the patient prepare for the visit and save perhaps 2-3 minutes for the doctor if all responses are “no,” as is generally the case or provide a focus on an important recent medical history from the “yes” answers. Similar features may be incorporated into some other questionnaires, but is not part of the report with feedback for the patient, as described below.

Completion of the 4-page version of the MDHAQ produces a report for patients to review information, one of example of which is the Patient Review Form shown in FIGS. 4A-4C that will become part of their medical record concerning their past history beyond the specific scores noted above, but as components of a standard medical history, including at any time (in contrast to the last 6 months above) operations, illnesses, diagnoses of different conditions, trauma, hospitalizations, family history, allergies to medications as well as general allergies, and social history.

All of this information from the MDHAQ is transmitted into the Patient Review Form (report), which the patient may review to ascertain whether all information is correct and is available indefinitely for updating, including correction of possible errors made over time in the record and amending new information (regarding operations or family history information and correcting errors that are often seen in medical records).

The patient is then given an opportunity to save all the information in 1001 to their own files through a memory stick or other device. This information is then available for any other doctor under care of the patient.

Although many systems are described as being “patient-centric,” it's rare that doctors will share this information on their own, unless part of the EMR network to which another doctor belongs. However, under these new systems, the patient has control of the information, the patient obviously having a much greater interest in ensuring that the information will become available to other doctors as compared to the staff at a given doctor's office. Again, although many systems speak of this transfer of information, it exists only rarely at present, generally and occasionally by highly motivated patients who exhibit considerably greater initiative that most patients, and not in the manner described in this application.

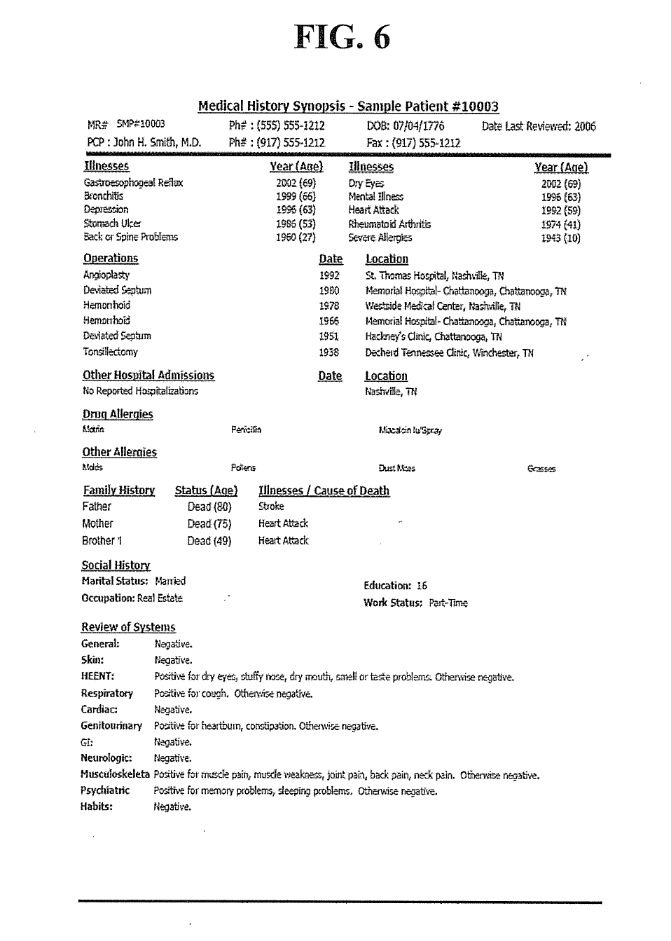

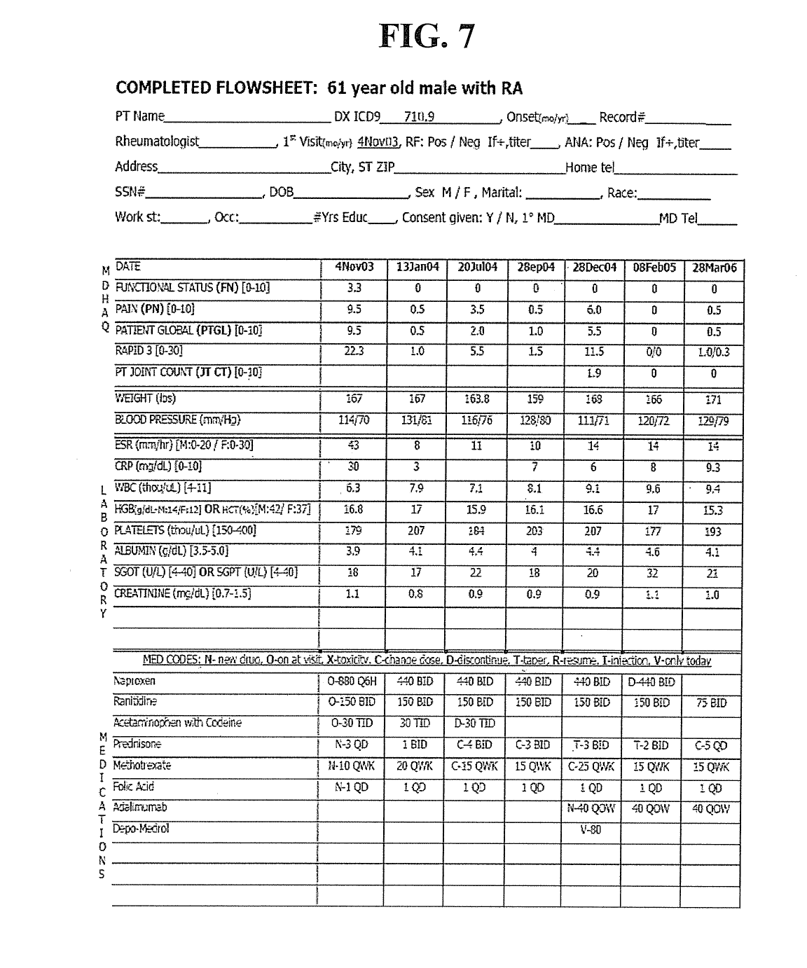

The information is also transmitted to a designated doctor or doctors for their own records in the format of a standard doctor's note, one example being shown in FIG. 6. This format relieves the doctor of dictation or typing most of the note and has been reviewed by the patient for accuracy in the use of the entire system.

As is noted above, the patient questionnaire (MDHAQ) not only collects data as narrative descriptions as is the case in many patient questionnaires, but asks for quantitative scores. There is a vast difference between a quantitative score to monitor patients with chronic disease versus a narrative description.

Consider a simple matter of keeping track of pain. A score for pain between 0-10 allows one to have a much better idea of improvement than a simple description “the pain is better” or “the pain is worse.” Consider an example, such as “it's hot outside” and it makes a big difference whether the temperature might say 80° F. versus 100° F., both of which would meet the criterion of the descriptor “hot,” or “this is an expensive shirt” which could involve the cost of $100 or $300, each of which would be expensive.

Similarly, if one had a score for physical function and wanted to know if it was better or worse, a score between 0-10 would be much better and more “scientific” than a simple description that the patient can function reasonably well or reasonably poorly or is “better or worse.” Scores given by patients for problems such as physical function, pain, fatigue, or exercise status may not be purely “scientific,” but rather may be considered subjective information. However, extensive scientific studies and analysis have documented that these scores are actually far more significant to predict survival and work disability than x-rays or laboratory tests, which are thought of as more “scientific” because of their origin and high technology sources. Therefore, the capacity to incorporate these scores is regarded as a major advance in the assessment and monitoring of chronic diseases such as rheumatic diseases, i.e., this is not really a cosmetic addition to what is already collected.

Another advancement involves using an organized format for patients to also provide a medical history in a standardized format. Thus, throughout the systems described above, the same database structure is maintained as a “scientific,” structured format, in contrast to the usual practice that questionnaires may be modified essentially at will if a change in format appears desirable. In this situation, the patient self-scoring is just as scientific and other types of patient information in achieving improved results, and is in a structured format.

The patient information review form is in a structured format for patients to make changes in the information in the medical history maintained for their care so that these changes might be Incorporated into a medical record rather than propagating errors and information that is out of date.

For example, if a patient has a recent operation or hospitalization for an accident or trauma, that information can be entered into the data management system by the patient to assure that it will be available at the next doctor visit, thus saving time for the doctor and providing more accurate information, since the doctor may or may not inquire about this information. The changes can be made on the MDHAQ or on the structured patient information review form. This redundancy may appear unnecessary, but is deliberate to try to capture this information which is regarded as vital to provide the most accurate data for patient care.

The system also provides a structured format for a review, which includes information in a checkmark form to help make a diagnosis of, for example, fibromyalgia, which is the most common rheumatic disease, most easily ascertained on the MDHAQ by 20 or more checkmarks as in several published reports. Fibromyalgia is a very expensive condition often generating extensive evaluations of laboratory tests, radiographs, MRI scans and other procedures and the capacity to identify patients with this condition on a simple questionnaire can be quite effective, particularly in patients who may meet criteria for more classical inflammatory diseases such as rheumatoid arthritis (RA) and systemic lupus erythematosus (SLE).

The MDHAQ also provides a self-report joint count, which is highly correlated with a standard tender joint count performed by a doctor, during a visit by the patient to the doctor. This can be a major saving to the physician of about 2 minutes and provides useful information to monitor specific joints and people with all types of arthritis, particularly osteoarthritis which generally involves fewer joints than rheumatoid arthritis.

The MDHAQ also provides a structured report for patients to change their medical history. The patients are able to amend, correct or ask questions about information in their standard medical history. Thus, every patient, when they check into the system (which can be at home but generally expected to be in a doctor's office), is given a specific format to enter changes, and demographic information, history of operations, illnesses, trauma, allergies, family history, as well as current medications. A number of research studies indicate discrepancies in many situations between what is recorded in the medical record as to the patient's medications and what is actually taken by the patient. Aspects of the present invention provide an opportunity to reconcile these two sources of information.

As noted above, the system provides a format for a doctor's note which is provided entirely by the patient, such as that shown in FIG. 6, requiring no typing other than review by the doctor or dictation, again, saving between 2 and 5 minutes of a new patient summary. In other systems, the doctor creates a note either by typing or dictation rather than automatically providing this information through the computer system.

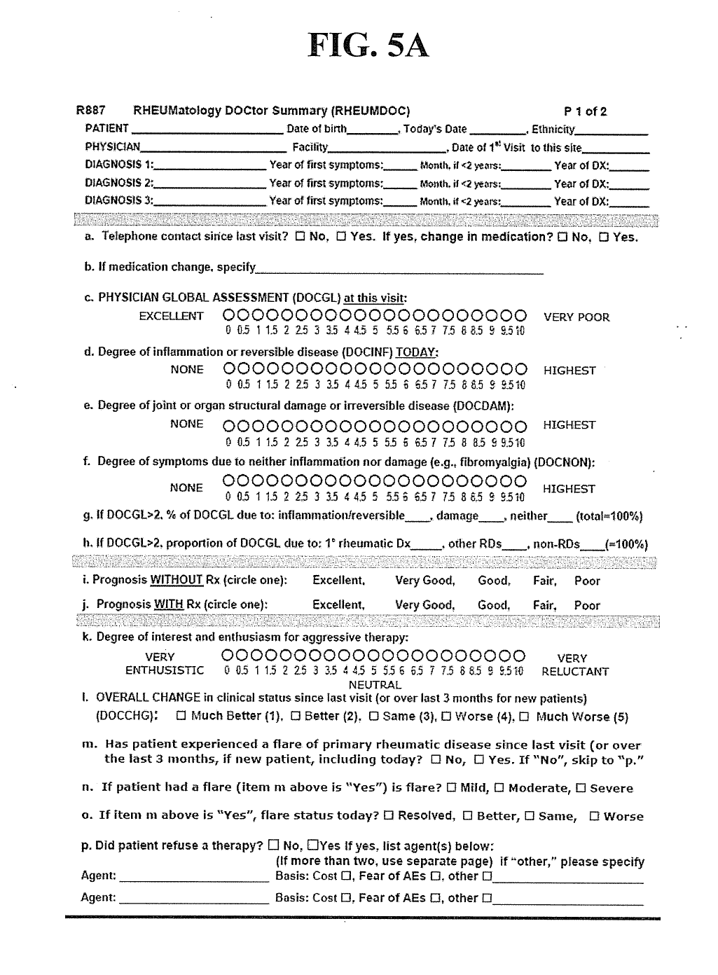

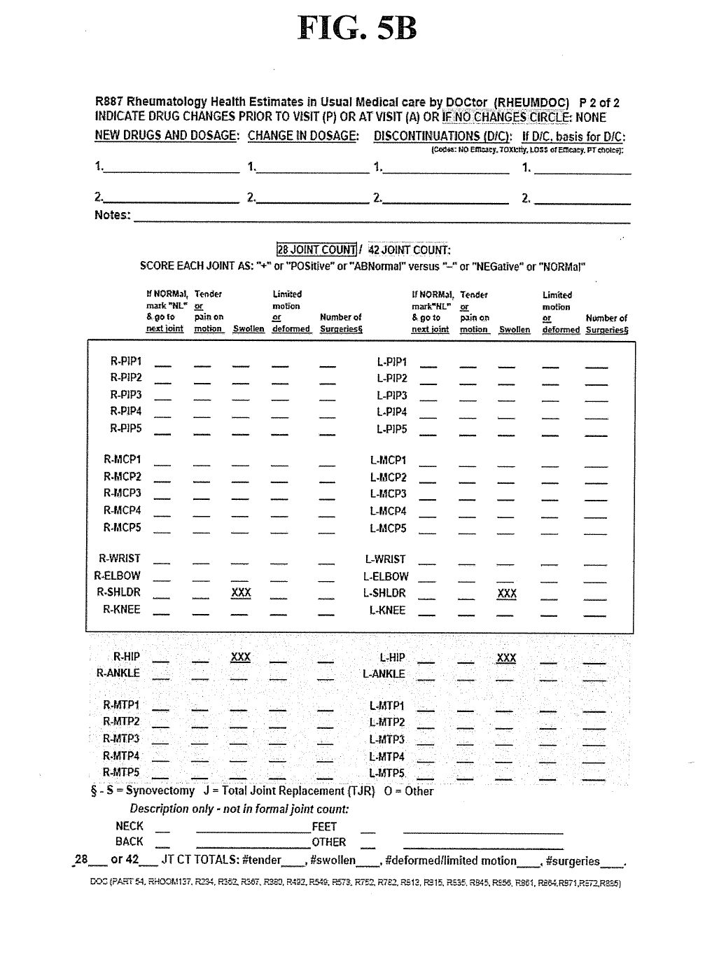

In the systems described in FIGS. 1 and 2, it is also possible to include a specific doctor form, known as Rheumatology Doctor Summary or RHEUMDOC with one example being shown in FIGS. 5A-5B, the purpose of which is to transform narrative information into quantitative scores from the doctor's perspective, consistent with the above rationale that quantitative scores add a major advance to monitor patients with chronic diseases. There are at least 3 features of RHEUMDOC, the data management system for the doctor's entry.

The first, involves a physician global estimate on a 0-10 scale consistent with the patient estimates for pain, global, status and fatigue, which are also scored 0-10 on a visual analog scale of 21 circles in 0.5 increments, and extensive research by the applicant has documented to be easier for both doctors and patients to complete and score into interpreting for clinical decisions.

The second is that there are 3 subscales also on 0-10 scores in which the doctor rates the levels of 3 common features of rheumatic diseases, inflammation, damage, and symptoms which reflect neither inflammation nor damage such as fibromyalgia. It is not generally recognized, but most visits to doctors for rheumatic diseases, but also for most symptoms about 80% of the time, result in no identified organic cause for the symptoms, a phenomenon that is not only not widely recognized but often misinterpreted to suggest that, at most doctor visits a series of “tests” such as laboratory tests, radiographs, MRI and other scans lead to a diagnosis in most cases. Actually, in most cases, these studies are negative but rating of this phenomenon in a quantitative manner has not been pursued to date and is incorporated into the present systems.

There is a quantitative estimate made of prognosis with and without therapy in the categories excellent, very good, good, fair, and poor, and these estimates are given for a patient with and without therapy because in some cases therapy might be anticipated to make a big difference and in others not. Although these phenomena underlie almost all clinical decisions in medical care, there has not been an effort, to attempt to record the doctor's estimate of prognosis as a quantitative score which provides a basis to analyze over time how accurate these estimates might be and hopefully to improve the capacity to establish a prognosis for each individual patient. An accurate assessment is designed, of course, to provide the best treatment, avoid undertreatment for conditions and situations in which a poor prognosis is anticipated or to avoid overtreatment when a good prognosis is anticipated and treatment need not be overly aggressive.

While not limited thereto, an advantage of an aspect of the invention is that the information is completed by the patient in an electronic format which can then be transmitted to an electronic or even paper medical record, without any effort of the physician to acquire the information, thus allowing more time for the physician to review, and interpret, and clarify important clues to diagnosis and management. This process can save at least 5-20 minutes for a new patient and 3-10 minutes for a returning patient, while improving completeness accuracy of the medical history.

While not limited thereto, an advantage of an aspect of the invention is that the EMH presents the medical history information concerning physical function, pain, global estimate, exercise status, fatigue in a standardized quantitative electronic format, which allows a medical history, which is often the most important information in diagnosis of many diseases, to be transformed from a narrative, non-quantitative format, to a quantitative, standardized format, the hallmark of scientific data rather than non-standard descriptions. In this way, the report for the physician is in a standard medical record format so there is no further need for the physician to collect data in a different format to transfer to a medical record format; and the standard format allows entering the information, with the patient's consent, into a database to monitor outcomes over time.

While not limited thereto, an advantage of an aspect of the invention is that the patient is provided an opportunity to save all the information entered electronically in the form of an email directly to the patient, a memory stick to be available at any medical site, or a password-protected website. The EMH would then be available for future visits at the same healthcare setting as well as any other healthcare facility including but not limited to medical physical therapy and exercise programs, for review by the patient and the health professional for updating, but without this feature in an emergency situation.

While not limited thereto, an advantage of an aspect of the invention is that the EMH database also has available voluntary (if selected) automated follow-up mechanisms so that the program can allow for any patient not seen for a given interval to be listed for contact with a telephone call, self-report questionnaire, invitation for a visit, etc.

While not limited thereto, an advantage of an aspect of the invention is that the patient is given an opportunity to consent to several features of the system. While not limited thereto, such features can include one or more of the following: maintenance of the EMH stored as an email, on a memory stick, and/or a password-protected website; monitoring, through periodic automated emails requesting maintenance of the EMH, to track patient status for long-term results for treatment; and program queries for a physician to know standard computations, including but not limited to: how many patients with each diagnosis are seen in the practice, how many patients with each diagnosis take specific medications, and what is the change in patient scores for physical function, pain, and global status over time.

While not limited thereto, an advantage of an aspect of the invention is that the patient may also consent to continued monitoring indefinitely over a lifetime; this monitoring would include data concerning predictors of survival according to different therapies and different baseline markers. This feature can save millions of dollars in outcome studies in the United States without jeopardizing the legal requirements of HIPAA if patients are willing to volunteer for such studies. Patient self-report data are more significant in the general population in predicting long term health than most laboratory tests and high technology imaging studies.

While not limited to a specific questionnaire, one aspect of the inventive system and method involves the patient filling out a standard medical history on a multidimensional health assessment questionnaire (MDHAQ). There are hundreds of available questionnaires for this purpose. While not limited thereto, the MDHAQ provides: an assessment of patient physical function and exercise status, which have been shown to be as likely as smoking history to predict poor 5-year survival in the general population; quantitative assessment of pain; quantitative assessment of global status; quantitative assessment of fatigue; review of systems; review of recent medical history; standard features of medical history, including but not limited to illnesses, operations, hospitalizations, family history, allergies, and medications; demographic variables; consent for further contact to allow follow-up of patient status; consent for sharing information with databases in a de-identified fashion; and consent for maintaining patient history in a database to allow other physicians and health professionals access; and consent for data to be stored and kept by the patient in an electronic format through a password-protected website, with options to allow access by physicians and other health professionals designated by the patient. Of course, additional data fields can be included in addition to or instead of one of these fields, although aspects of the invention do not allow replacement of the these fields. The data are available in the physician report form to be incorporated into a standard patient history. The software and concept are unique to this system. A report is available for patients to electronically modify, amend, or correct the medical history.

It should be emphasized that in an aspect of the proposed system, for recording the patient history and maintaining it to be available over the lifetime of any individual patient, is distinguishable from a patient medical record. The patient medical record is a legal document protected by the Health Insurance Portability and Accountability Act (HIPAA) and not modifiable. The proposed EMH involves only the patient history controlled by the patient. This patient medical history is not controlled by any regulations and should be properly regarded as the property of the patient. No medical data should be available to any database without appropriate patient consent. Therefore, in this embodiment of the system, the patient would be responsible for any possible entries from the medical record, which might include hospitalization records, discharge summaries, laboratory tests, radiographic reports, cardiograms available for comparison to future events, records of devices (such as replacement lenses, total joint replacement, prostheses, and pacemakers), and other vital information which would be desirable to have available in case of emergency, or any other medical visit, at which a computer listing that has been reviewed, often repeatedly, is likely to be more accurate than a patients memory.

A unique feature of an embodiment of the system involves the capacity for the medical history information to be transferred to a medical record in a standard format of the traditional medical record. This step is viewed as saving doctors at least 10 minutes per new patient and at least 3 minutes per return patient, with information that is necessary to collect at each patient visit in order to make optimal clinical decisions, but which is often neglected in the press of time in contemporary medical care. Therefore, the process is viewed as not only saving time for the doctor but likely improving medical care with provision of more information than is usually available to make decisions about diagnosis, prognosis, therapeutic interventions, and outcomes.

While not limited thereto, it is understood that aspects of the system and method can be implemented using computer software and/or firmware encoded on one or more computer readable media or other non-transitory media readable by a processor and/or computer and implemented using one or more processors and/or computers.

Although multiple embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An information system designed to improve prognosis, monitoring, and assessment of outcomes in patient with chronic diseases, which includes first and second standardized, structured questionnaires, the first standardized questionnaire for patients and the second standardized questionnaire for physicians, in electronic or paper format, including quantitative scores of clinical status to be uniquely entered into standard medical record and reports to the patients, to doctors, and electronic medical records (EMRs) the system comprising:
a first database to collect the first questionnaire from a patient-held device, computer or paper, with quantitative patient self-report scores for physical function, pain, fatigue, global status and exercise status, with a system for tracking these scores to be inserted directly into a medical record note in standard electronic medical record (EMR) format with no dictation or typing by a doctor;
the first questionnaire also including past history of operations, illnesses, hospitalizations, allergies, medications, family history, social history, with the same system for tracking these data to be inserted directly into a medical record visit note in standard electronic medical record (EMR) format with no dictation or typing by a doctor;
wherein information from the first questionnaire is in a structured user-friendly format for the patient to amend, correct errors, and update medical history information and enterable into an electronic medical record;
an electronic version of the structured medical history to be available to other health professionals, regardless of the EMR or other system;
a second database to collect the second questionnaire, the second questionnaire includes unique quantitative scores by the doctor concerning reversible, irreversible and somatization basis for patient symptoms, and quantitative estimates of prognosis with and without therapy, which is enterable in the standard medical record format;
a computer, which controls access of the first questionnaire stored in the first database, with consent of the patient, to any doctor and the second questionnaire stored in the second database, which receives information directly from a first device of the patient or the first database and transmits doctor reviewed data to a second device of the doctor for the doctor to review patient information from the patient for a visit note to be entered into the electronic medical record (EMR); and
wherein the questionnaire is provided by the patient, the second questionnaire by the doctor, the first and second questionnaires being entered into the EMR which is not in any way alterable once approved by the doctor, and an electronic medical history is alterable by the patient prior to a next visit or enterable into the electronic medical record of the next visit through addition or change of new first questionnaire, after approval by the doctor.
